(19) United States
(12) Patent Application Publication
(10) Pub. No.: US 2010/0103053 A1
(43) Pub. Date: Apr. 29, 2010

(54) CIRCULARLY POLARIZED ANTENNA

(75) Inventors: Pavel Nikitin, Seattle, WA (US); Venkata Kodukula, Bothell, WA (US); For Sander Lam, Bothell, WA (US)

Correspondence Address: SEED INTELLECTUAL PROPERTY LAW GROUP PLLC, 701 FIFTH AVENUE, SUITE 5400, SEATTLE, WA, 98104-7092, US

(73) Assignee: INTERMEC IP CORP., Everett, WA (US)

(21) Appl. No.: 12/258,609

(22) Filed: Oct. 27, 2008

(51) Int. Cl. H01Q 1/36; H01Q 1/24

(52) U.S. Cl. 343/702; 343/895

(57) ABSTRACT

A circularly polarized antenna includes a generally helical wire defining a generally cylindrical passage having a first end and a second end. A first ground plane is proximate the first end of the generally cylindrical passage and has a width substantially equal to a diameter of the generally cylindrical passage. A cable extends through the generally cylindrical passage and is electrically coupled to the first ground plane and to the generally helical wire proximate the first end.

### BACKGROUND

1. Technical Field

This description generally relates to the field of wireless communications, and more particularly to a circularly polarized antenna for wireless communications.

2. Description of the Related Art

Compact wireless communication devices typically include antennas that have a relatively large beamwidth and relatively low gain. In some devices, small, patch antennas are used. In other devices, helical antennas may be used in a normal mode, transmitting and receiving with a relatively broad beamwidth in normal directions relative to the helical axis.

However, for certain compact devices, such as portable wireless interrogators, higher gain antennas must be used. Helical antennas, when operated in an axial mode, are capable of producing moderate to high gain over a relatively wide bandwidth with good circular polarization. Unfortunately, in order to achieve a directional, high gain signal, helical antennas typically require a tall height (e.g., about one foot for ultra-high frequency (“UHF”) signals), and a large ground plane diameter (e.g. about one foot for UHF signals). These dimensions have made it nearly impossible to incorporate helical antennas operating in an axial mode into compact wireless communication devices.

As a result, there is a need in the art for an improved antenna for transmitting circularly polarized electromagnetic signals.

### BRIEF SUMMARY

A circularly polarized antenna may be summarized as comprising: a generally helical wire defining a generally cylindrical passage having a first end and a second end; a first ground plane proximate the first end of the generally cylindrical passage, the first ground plane having a width substantially equal to a diameter of the generally cylindrical passage; and a cable extending through the generally cylindrical passage, the cable electrically coupled to the first ground plane and to the generally helical wire proximate the first end.

The generally helical wire and the first ground plane may be adapted and dimensioned to transmit electromagnetic signals in backfire mode in a direction from the second end to the first end of the generally cylindrical passage. A substantial majority of the electromagnetic signals transmitted by the circularly polarized antenna during operation may be transmitted within a 90 degree cone centered about a central longitudinal axis of the generally cylindrical passage, the 90 degree cone originating (i.e. having an apex) at the second end and extending in the direction from the second end to the first end. A substantial majority of the electromagnetic signals transmitted by the circularly polarized antenna during operation may also be transmitted within a 70 degree cone centered about the central longitudinal axis of the generally cylindrical passage, the 70 degree cone originating at the second end and extending in the direction from the second end to the first end.

The circularly polarized antenna may further comprise a second ground plane proximate the second end of the generally cylindrical passage, the second ground plane having a width substantially equal to the diameter of the generally cylindrical passage. The second ground plane may be adapted and dimensioned to function as a reflector during operation.

The circularly polarized antenna may further comprise: a cable port proximate the second end of the generally cylindrical passage, the cable port coupled to the cable and adapted to receive an external coaxial cable. The circularly polarized antenna may further comprise a radome substantially surrounding the generally helical wire, and/or a core about which the generally helical wire is at least partially wound. The radome, the core and the generally cylindrical passage may be substantially concentric. The core may be hollow, or at least partially filled with a dielectric material having a dielectric constant greater than that of air.

The cable may extend substantially along a central longitudinal axis of the generally cylindrical passage. The generally helical wire and the first ground plane may be adapted and dimensioned to transmit electromagnetic signals having an axial ratio of less than 3 dB. The generally helical wire and the first ground plane may further be adapted and dimensioned to transmit electromagnetic signals with a gain of approximately 6 dBi. The cable may comprise a coaxial cable, and a shield of the coaxial cable may be electrically coupled to the first ground plane, and a core of the coaxial cable may be electrically coupled to the generally helical wire.

A wireless interrogator for emitting wireless interrogation signals may be summarized as including: a wireless signal generator; and a circularly polarized antenna coupled to the wireless signal generator, the circularly polarized antenna including: a generally helical wire defining a generally cylindrical passage having a first end and a second end; a first ground plane proximate the first end of the generally cylindrical passage, the first ground plane having a width substantially equal to a diameter of the generally cylindrical passage; and a cable extending through the generally cylindrical passage and communicatively coupled to the wireless signal generator, the cable electrically coupled to the first ground plane and to the generally helical wire proximate the first end.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic view of a circularly polarized antenna coupled to a wireless signal generator, according to one illustrated embodiment.

FIG. 2 is a schematic view of another circularly polarized antenna, according to one illustrated embodiment.

FIG. 3 is a side view of the circularly polarized antenna of FIG. 2, according to one illustrated embodiment.

FIG. 4 is an exploded view of the circularly polarized antenna of FIG. 2, according to one illustrated embodiment.

FIG. 5 is a chart illustrating an exemplary radiation pattern for the circularly polarized antenna of FIG. 2, according to one illustrated embodiment.

FIG. 6 is another chart illustrating an exemplary radiation envelope for the circularly polarized antenna of FIG. 2, according to one illustrated embodiment.

FIG. 7 is a chart illustrating an exemplary gain, axial ratio and voltage standing wave ratio as a function of frequency for the circularly polarized antenna of FIG. 2, according to one illustrated embodiment.

FIG. 8 is a schematic view of a wireless interrogator incorporating the circularly polarized antenna of FIG. 2, according to one illustrated embodiment.

FIG. 9 is a side view of a wireless interrogator incorporating the circularly polarized antenna of FIG. 2, according to one illustrated embodiment.

### DETAILED DESCRIPTION OF EMBODIMENTS OF THE INVENTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with integrated circuits, antennas, and radio frequency transmitters and receivers have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the embodiments.

### Description of an Exemplary Circularly Polarized Antenna

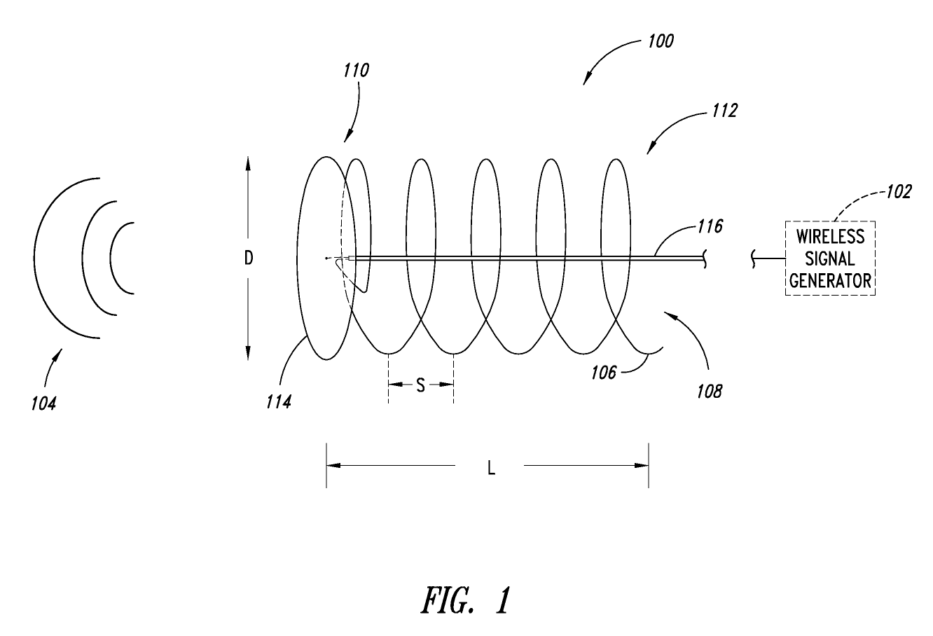

FIG. 1 shows a circularly polarized antenna 100, according to one illustrated embodiment. During operation, the circularly polarized antenna 100 may be coupled to any of a variety of wireless signal generators 102 configured to drive the circularly polarized antenna 100. As illustrated, the circularly polarized antenna 100 may be configured to transmit circularly polarized electromagnetic signals 104 when driven by the wireless signal generator 102 (e.g., right hand circularly polarized (“RHCP”) signals or left hand circularly polarized (“LHCP”) signals, depending upon the configuration).

In one embodiment, the circularly polarized antenna 100 may include a generally helical wire 106 defining a generally cylindrical passage 108 having a first end 110 and a second end 112. This generally helical wire 106 may comprise an antenna element of the circularly polarized antenna 100 configured to carry electrical signals generated by the wireless signal generator 102. The generally helical wire 106 may have a variety of dimensions. For example, a spacing S between adjacent coils of the generally helical wire 106, a diameter D of the generally cylindrical passage 108, or a length L of the generally cylindrical passage 108 may each have any of a variety of values. In one embodiment, to improve the portability of the antenna 100, the length L and the diameter D may be chosen to be less than or equal to 6″ each. For example, the length L and the diameter D may each be chosen to be approximately equal to 4″. In some embodiments, different ratios of the above dimensions may be chosen to achieve particular characteristics for the antenna 100, as described in greater detail below.

In some embodiments, the generally helical wire 106 need not form a perfect geometric helix. For example, the generally helical wire 106 may form a generally cylindrical passage 108 that narrows or widens from the first end 110 to the second end 112. In addition, the spacing S between adjacent coils may vary along the length L of the generally cylindrical passage 108. Some portions of the generally helical wire 106 may also widely deviate from a generally helical pattern. For example, as illustrated, a portion of the wire 106 proximate the first end 110 may approach a central longitudinal axis of the generally cylindrical passage 108.

The generally helical wire 106 may comprise any of a variety of conducting materials. In one embodiment, the generally helical wire 106 may comprise a metallic conductor adapted to carry electrical signals from the wireless signal generator 102.

The circularly polarized antenna 100 may further include a first ground plane 114 proximate the first end 110 of the generally cylindrical passage 108. In one embodiment, the first ground plane 114 may have a width substantially equal to the diameter D of the generally cylindrical passage 108. For example, in one embodiment, the width of the first ground plane 114 may be between 80% and 120% of the diameter D of the generally cylindrical passage 108. In another embodiment, the width of the first ground plane 114 may be between 90% and 110% of the diameter D of the generally cylindrical passage 108.

Although illustrated as a generally circular element, the first ground plane 114 may have a variety of shapes. In one embodiment, for example, the first ground plane 114 may comprise a rectilinear shape having a width substantially equal to the diameter D. The first ground plane 114 may also comprise any of a variety of conducting materials, such that the first ground plane 114 serves as a ground plane for the circularly polarized antenna 100. In one embodiment, the first ground plane 114 may comprise a metallic sheet.

The circularly polarized antenna 100 may further include a cable 116 extending through the generally cylindrical passage 108. The cable 116 may be electrically coupled to the first ground plane 114 and to the generally helical wire 106 proximate the first end 110 of the generally cylindrical passage 108. In one embodiment, the cable 116 extends from the second end 112 to proximate the first end 110 of the generally cylindrical passage 108, where the cable 116 may be coupled to the first ground plane 114 and the generally helical wire 106. In addition, the cable 116, as illustrated, may be communicatively coupled to the wireless signal generator 102. In another embodiment, the cable 116 may be electrically coupled to the first ground plane 114 and to the generally helical wire 106 proximate the first end 110 of the generally cylindrical passage 108 but may not extend through the generally cylindrical passage 108.

In one embodiment, the cable 116 may extend substantially along a central longitudinal axis of the generally cylindrical passage 108. Such an arrangement may mitigate interference between the circularly polarized signals 104 generated by the antenna 100 and the signals carried by the cable 116. Of course, in other embodiments, the cable 116 may extend off the central longitudinal axis of the generally cylindrical passage 108.

The cable 116 may comprise one or more conductors configured to transmit electrical signals from the wireless signal generator 102 to the generally helical wire 106. These conductors may be arranged in a variety of ways within the cable 116. In one embodiment, the cable 116 may comprise a coaxial cable. In such an embodiment, a shield of the coaxial cable may be electrically coupled to the first ground plane 114, and a core of the coaxial cable may be electrically coupled to the generally helical wire 106.

In some embodiments, the circularly polarized antenna 100 may comprise only the generally helical wire 106, the first ground plane 114 and the cable 116. However, in other embodiments, additional structures may be included. Some of these structures are illustrated in the following figures.

As illustrated in FIG. 1, the circularly polarized antenna 100 may be configured to transmit electromagnetic signals 104 in backfire mode. That is, the generally helical wire 106 and the first ground plane 114 may be adapted and dimensioned to transmit electromagnetic signals 104 in backfire mode in a direction from the second end 112 to the first end 110.

The illustrated configuration of the circularly polarized antenna 100 may also facilitate the transmission of a highly directional electromagnetic signal. In one embodiment, during operation, a substantial majority of the electromagnetic signals 104 transmitted by the circularly polarized antenna 100 may be transmitted within a 90° cone centered about a central longitudinal axis of the generally cylindrical passage 108, the 90° cone originating at the second end 112 (i.e., having an apex at the second end 112) and extending in the direction from the second end 112 to the first end 110. In another embodiment, during operation, a substantial majority of the electromagnetic signals 104 transmitted by the circularly polarized antenna 100 may be transmitted within a 70° cone centered about the central longitudinal axis of the generally cylindrical passage 108, the 70° cone originating at the second end 112 and extending in the direction from the second end 112 to the first end 110. For example, 70% or more of the electromagnetic energy may be transmitted within the above-described cones. In another embodiment, 80% or more of the electromagnetic energy may be transmitted within the above-described cones.

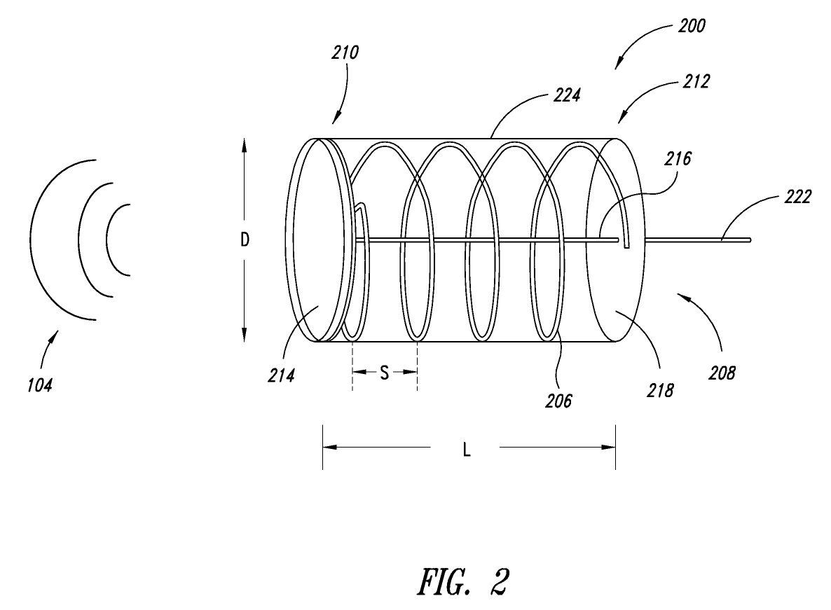

In one embodiment, the generally helical wire 106 and the first ground plane 114 may also be adapted and dimensioned to transmit electromagnetic signals 104 having an axial ratio of less than 3 dB. In another embodiment, the generally helical wire 106 and the first ground plane 114 may be adapted and dimensioned to transmit electromagnetic signals 104 having an axial ratio of less than 2 dB. In one embodiment, the generally helical wire 106 and the first ground plane 114 may be adapted and dimensioned to transmit electromagnetic signals 104 with a gain of approximately 6 dBi. Even higher gains are possible in other embodiments. Some exemplary dimensions for the generally helical wire and the first ground plane are provided below with respect to the antenna embodiment of FIG. 2 et seq.

### Description of Another Exemplary Circularly Polarized Antenna

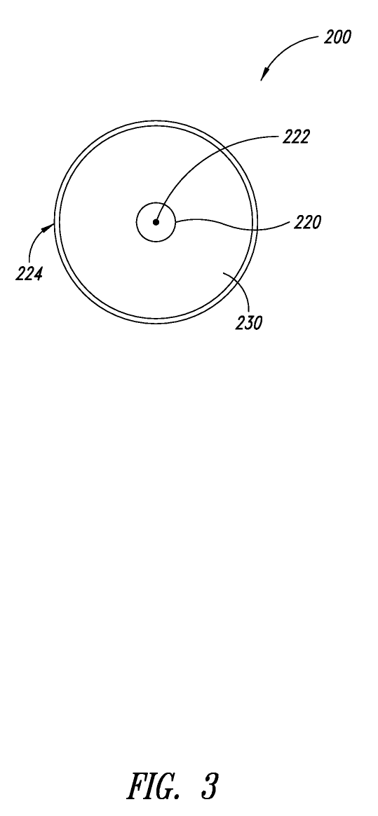

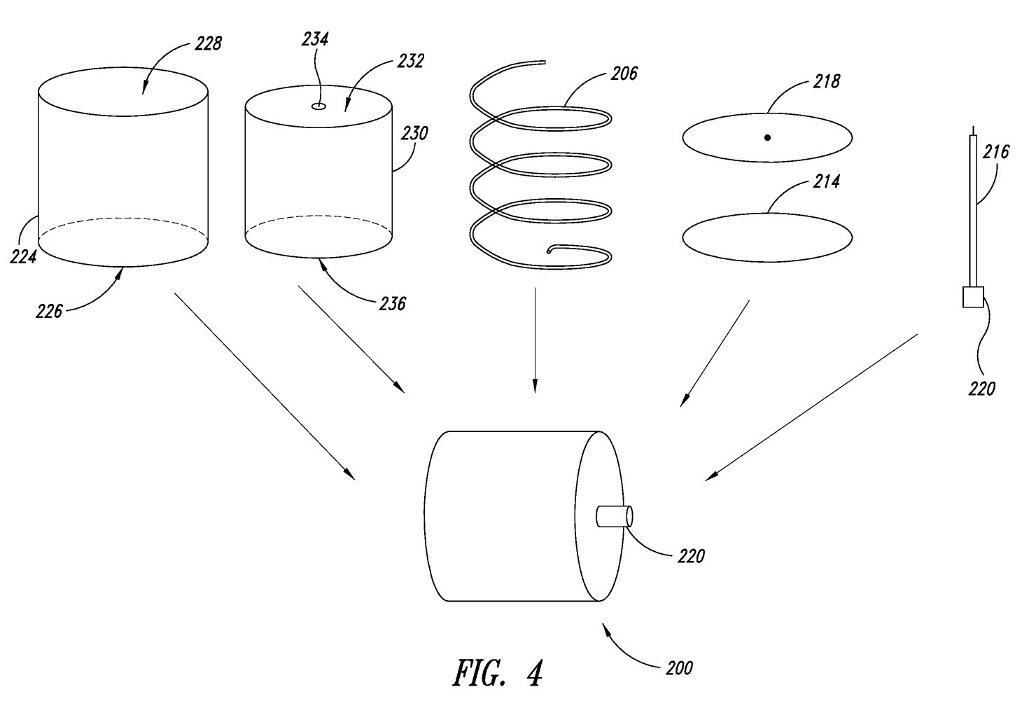

FIG. 2 shows another circularly polarized antenna 200, according to one illustrated embodiment. FIG. 3 is a side view and FIG. 4 is an exploded view of the circularly polarized antenna 200. As illustrated, the circularly polarized antenna 200 may be configured similarly to the circularly polarized antenna 100, with like numerals referring to like parts. However, the circularly polarized antenna 200 may also include additional components, as described in greater detail below.

In one embodiment, the circularly polarized antenna 200 may include a second ground plane 218 proximate the second end 212 of the generally cylindrical passage 208. The second ground plane 218 may have a width substantially equal to a diameter D of the generally cylindrical passage 208. In one embodiment, the first ground plane 214 and the second ground plane 218 may have substantially similar dimensions and geometry, and they may be formed from the same materials. However, in other embodiments, the ground planes 214, 218 may be very differently configured, and the second ground plane 218 may have any of a variety of shapes. During operation, the second ground plane 218 may be adapted and dimensioned to function as a reflector.

In one embodiment, the second ground plane 218 may also be electrically coupled to the cable 216. For example, if the cable 216 comprises a coaxial cable, the second ground plane 218 may be electrically coupled to a shield of the cable 216. Thus, the second ground plane 218 and the first ground plane 214 may be electrically coupled in some embodiments. In other embodiments, the second ground plane 218 may not be electrically coupled to any of the other components of the circularly polarized antenna 200.

In one embodiment, the circularly polarized antenna 200 may further include a cable port 220 (illustrated in FIGS. 3 and 4). The cable port 220 may be positioned proximate the second end 212 of the generally cylindrical passage 208 and may be coupled to the cable 216. In one embodiment, the cable port 220 may be adapted to receive an external coaxial cable 222 (shown in FIGS. 2 and 3), thus communicatively coupling the circularly polarized antenna 200 with a wireless signal generator (not shown). The cable port 220 may comprise any of a variety of cable ports adapted to receive a coaxial cable. In other embodiments, the cable 216 may be coupled directly to a wireless signal generator without the use of a cable port.

The circularly polarized antenna 200 may further comprise a radome 224 substantially surrounding the generally helical wire 206. The radome 224 may be adapted and dimensioned to protect the generally helical wire 206 (as well as other internal elements of the antenna 200) from environmental stresses. In one embodiment, the radome 224 may comprise a plastic housing. In other embodiments, other non-conductive materials may be used.

As best shown in FIG. 4, the radome 224 may comprise a generally cylindrical tube. The radome 224 may have one solid end 226 and one open end 228. In other embodiments, other configurations for the radome 224 may be employed.

The circularly polarized antenna 200 may further comprise a core 230 about which the generally helical wire 206 is at least partially wound. The core 230 may be adapted and dimensioned to support the generally helical wire 206. In one embodiment, the core 230 may comprise a generally cylindrical tube, as illustrated in FIG. 4. Configured similarly to the radome 224, the core 230 may have one solid end 232 with a single hole 234 to accommodate the cable 216, and one open end 236. In order for the core 230 to fit within the radome 224, the core 230 may have a slightly smaller diameter. In other embodiments, other configurations for the core 230 may be employed.

In one embodiment, the core 230 may be hollow. However, in other embodiments, the core 230 may be at least partially filled with a dielectric material (e.g., a ceramic material) having a dielectric constant greater than that of air. In such an embodiment, the circularly polarized antenna 200 may be made smaller due to the greater efficiency of the dielectric material.

When assembled, the solid end 226 of the radome 224 may be proximate the first end 210 of the generally cylindrical passage 208, and the open end 228 may be proximate the second end 212 of the generally cylindrical passage 208. Meanwhile, the solid end 232 of the core 230 may be proximate the second end 212 of the generally cylindrical passage 208, and the open end 236 may be proximate the first end 210 of the generally cylindrical passage. In one embodiment, the generally helical wire 206 may be positioned between these cylinders 224, 230. The radome 224, the core 230 and the generally cylindrical passage 208 may be substantially concentric when assembled, in one embodiment. For example, each of these components may be concentric about a central longitudinal axis of the generally cylindrical passage 208.

The radome 224 and the core 230 may also be used to carry the first and second ground planes 214, 218, respectively. For example, the radome 224 may carry the first ground plane 214, glued or otherwise affixed to the solid end 226. Meanwhile, the core 230 may carry the second ground plane 218, glued or otherwise affixed to the solid end 232. In other embodiments, the ground planes 214, 218 may comprise portions of the radome 224 and the core 230 and may be formed integrally with these components. In other embodiments, still other arrangements may be used to form the circularly polarized antenna 200.

In some embodiments, the circularly polarized antenna 200 may lack one or more of the above elements. For example, in one embodiment, the core 230 may be omitted. In another embodiment, the radome 224 may be omitted, and the core 230 provided.

### Description of Exemplary Test Data

Some approximate design formulas for the circularly polarized antenna 200 described above may be used to estimate how such an antenna might perform. For example, an operative frequency of the antenna 200 may be approximated using the following equation:

$$Frequency \approx 1.5 \frac{c}{\sqrt{ɛ} \sqrt{{( π D )}^{2} + {S}^{2}}}$$

In this frequency equation, c is the speed of light, ∈ is the dielectric permittivity of a dielectric material within the core 230, D is the diameter of the generally cylindrical passage 208, and S is the spacing between adjacent coils of the generally helical wire 206. An axial ratio of the antenna 200 may be approximated using the following equation:

$$AxialRatio \approx \frac{N + 1}{N}$$

In this axial ratio equation, N is the number of turns of the generally helical wire 206. Finally, a gain for the antenna 200 may be approximated using the following equation:

$$Gain \approx 3 N \frac{{( \sqrt{ɛ} )}^{3} {( π D )}^{2} S}{{λ}^{3}}$$

In this gain equation, ∈ is the dielectric permittivity of a dielectric material within the core 230, D is the diameter of the generally cylindrical passage 208, S is the spacing between adjacent coils of the generally helical wire 206, N is the number of turns of the generally helical wire 206, and λ is a wavelength of the emitted electromagnetic signals 204.

In one embodiment, a plastic radome 224 and a solid core 230 made from ABS may be used to form a circularly polarized antenna configured similarly to the circularly polarized antenna 200 illustrated in FIGS. 2-4. ABS has a dielectric permittivity of approximately 3.5. In such an embodiment, a diameter D of 85 mm and a length L of 130 mm may be used. Such an antenna may have the following approximate characteristics: an operative frequency of between 865 and 870 MHz; a gain of 6 dBi; a vertical standing wave ratio (“VSWR”) of less than 1.5:1; an axial ratio of 2 dB; a front-to-back ratio of greater than 10 dB; a horizontal beamwidth of less than 70 degrees; and a vertical beamwidth of less than 70 degrees.

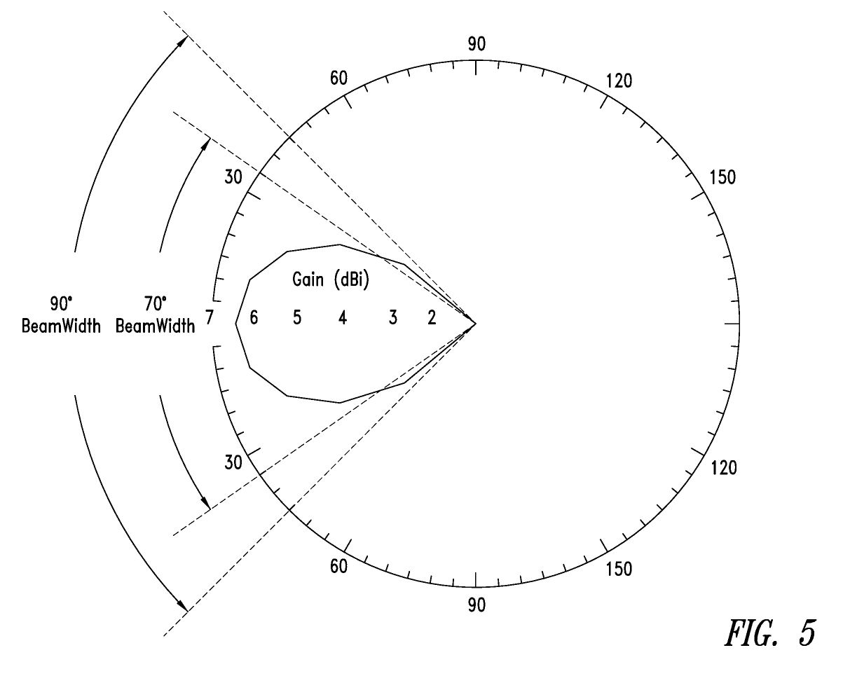

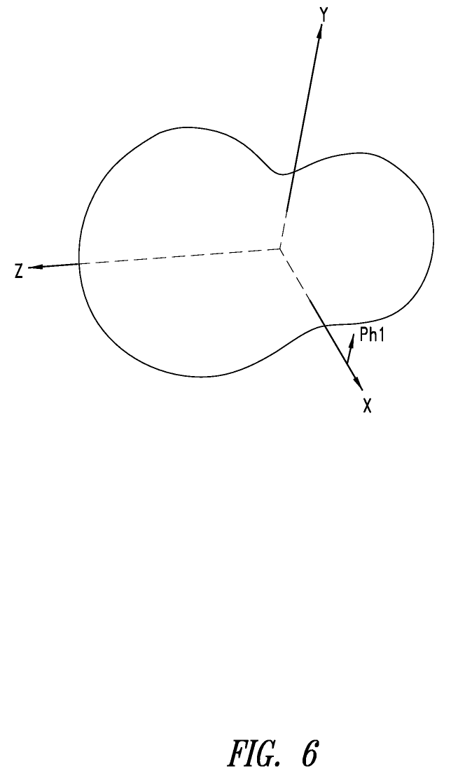

FIGS. 5 and 6 are charts illustrating exemplary, simulated radiation patterns for the circularly polarized antenna 200 having the above dimensions. As illustrated, the circularly polarized antenna 200 may have a gain of approximately six dBi, and may transmit a substantial majority of its electromagnetic signals within a 90° cone. Indeed, in one embodiment, the circularly polarized antenna 200 may be configured to transmit a substantial majority of its electromagnetic signals within a 70° cone.

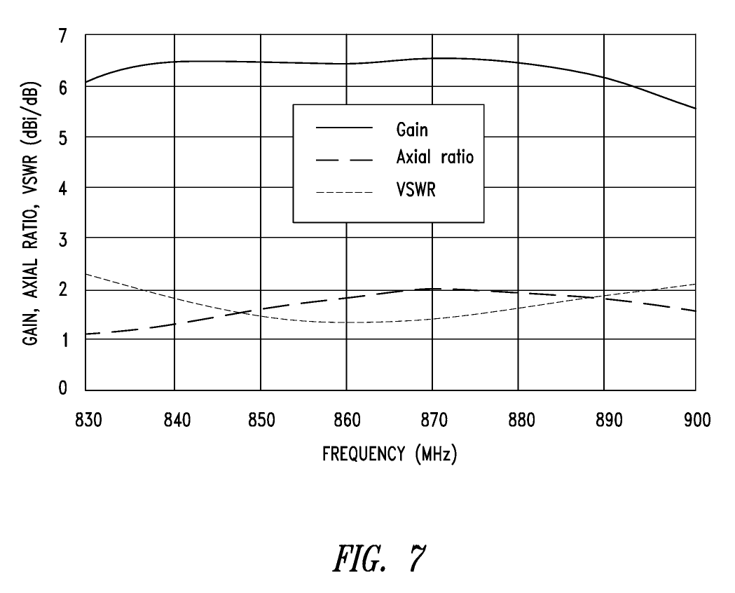

FIG. 7 is a chart illustrating an exemplary gain, axial ratio and voltage standing wave ratio (“VSWR”) as a function of frequency for the circularly polarized antenna 200 having the above dimensions, as obtained using a prototype of such an antenna.

In other embodiments, the circularly polarized antenna 200 may have any of a variety of performance characteristics. For example, in different embodiments, the circularly polarized antenna 200 may be adapted and dimensioned to communicate optimally over different frequency ranges. For example, the circularly polarized antenna 200 may be configured to communicate over a range of frequencies, such as 860-930 MHz, 2.45 GHz, or 5.8 GHz. In other embodiments, the gain of the circularly polarized antenna 200 may fall substantially below 6 dBi in an operating frequency in order to achieve, for example, a smaller form factor. In still other embodiments, an axial ratio of the circularly polarized antenna 200 may exceed 3 dB over its operating frequency.

### Description of an Exemplary Wireless Interrogator

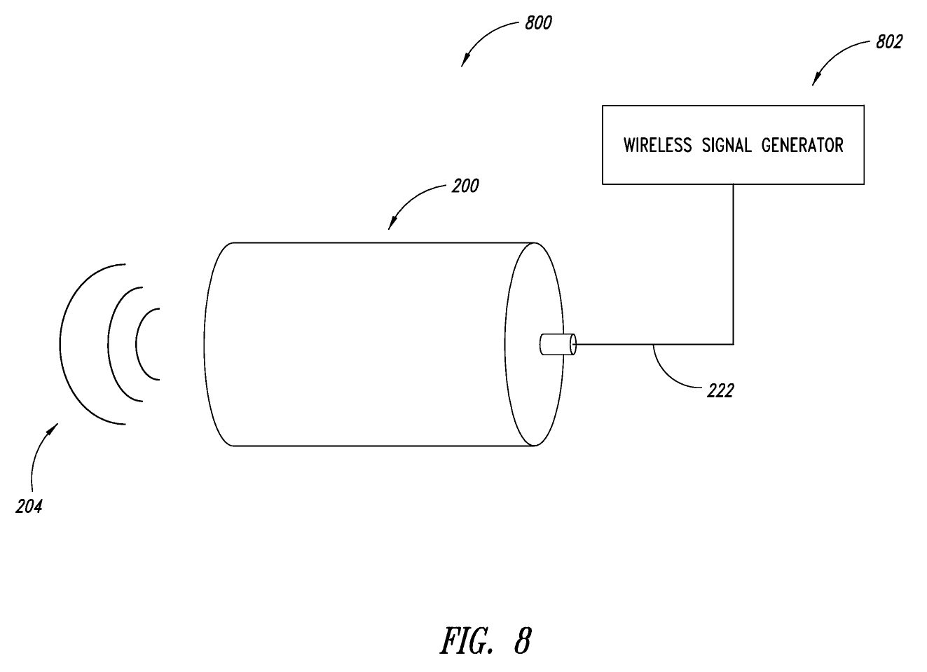

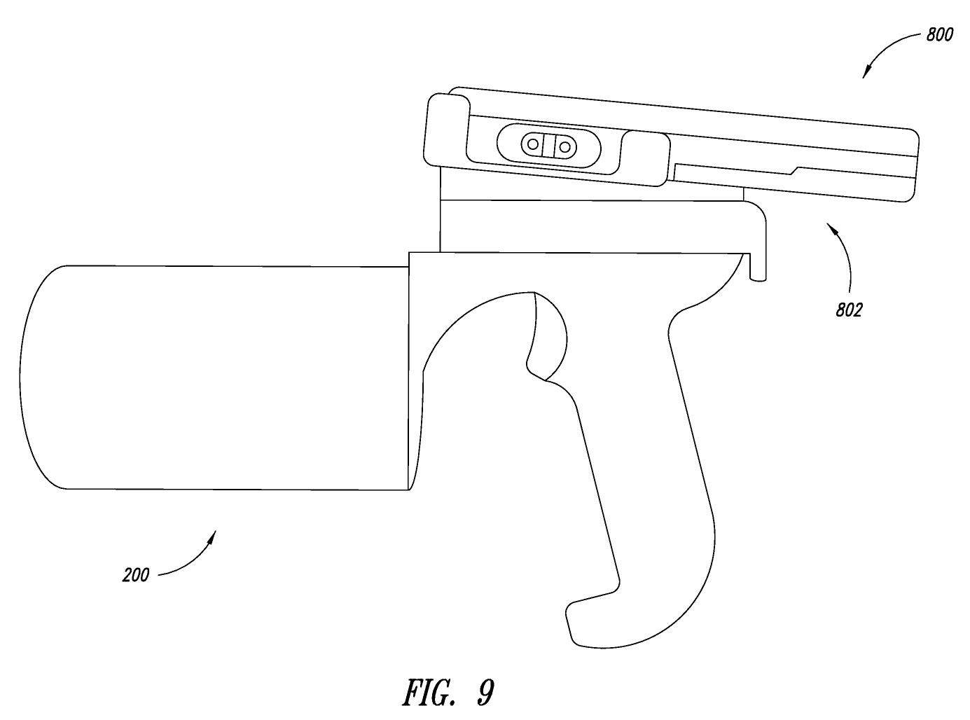

FIG. 8 is a schematic representation of an exemplary wireless interrogator 800 including the circularly polarized antenna 200 of FIG. 2 coupled to a wireless signal generator 802. FIG. 9 illustrates a side view of one exemplary form that the wireless interrogator 800 might take. The above description of the circularly polarized antenna 200 applies equally to the wireless interrogator 800.

In one embodiment, the cable 216 of the circularly polarized antenna 200 may be communicatively coupled to the wireless signal generator 802, and the circularly polarized antenna 200 may thus be driven by the wireless signal generator 802. For example, an external cable 222 may connect the circularly polarized antenna 200 to the wireless signal generator 802.

The wireless interrogator 800 may comprise any of a variety of devices configured to query wireless communication devices. For example, the wireless interrogator 800 may comprise a radio frequency interrogator configured to communicate with and/or energize radio frequency identification (“RFID”) wireless devices.

The various embodiments described above can be combined to provide further embodiments. From the foregoing it will be appreciated that, although specific embodiments have been described herein for purposes of illustration, various modifications may be made without deviating from the spirit and scope of the teachings. Accordingly, the claims are not limited by the disclosed embodiments.

We/I claim:

1. A circularly polarized antenna, comprising:
a generally helical wire defining a generally cylindrical passage having a first end and a second end;
a first ground plane proximate the first end of the generally cylindrical passage, the first ground plane having a width substantially equal to a diameter of the generally cylindrical passage; and
a cable extending through the generally cylindrical passage, the cable electrically coupled to the first ground plane and to the generally helical wire proximate the first end.

2. The circularly polarized antenna of claim 1, wherein the generally helical wire and the first ground plane are adapted and dimensioned to transmit electromagnetic signals in backfire mode in a direction from the second end to the first end.

3. The circularly polarized antenna of claim 2, wherein a substantial majority of the electromagnetic signals transmitted by the circularly polarized antenna during operation are transmitted within a 90 degree cone centered about a central longitudinal axis of the generally cylindrical passage, the 90 degree cone originating at the second end and extending in the direction from the second end to the first end.

4. The circularly polarized antenna of claim 3, wherein the substantial majority of the electromagnetic signals transmitted by the circularly polarized antenna during operation are transmitted within a 70 degree cone centered about the central longitudinal axis of the generally cylindrical passage, the 70 degree cone originating at the second end and extending in the direction from the second end to the first end.

5. The circularly polarized antenna of claim 1, further comprising a second ground plane proximate the second end of the generally cylindrical passage, the second ground plane having a width substantially equal to the diameter of the generally cylindrical passage.

6. The circularly polarized antenna of claim 5, wherein the second ground plane is adapted and dimensioned to function as a reflector during operation.

7. The circularly polarized antenna of claim 1, further comprising:
a cable port proximate the second end of the generally cylindrical passage, the cable port coupled to the cable and adapted to receive an external coaxial cable.

8. The circularly polarized antenna of claim 1, further comprising a radome substantially surrounding the generally helical wire.

9. The circularly polarized antenna of claim 8, further comprising a core about which the generally helical wire is at least partially wound.

10. The circularly polarized antenna of claim 9, wherein the radome, the core and the generally cylindrical passage are substantially concentric.

11. The circularly polarized antenna of claim 9, wherein the core is hollow.

12. The circularly polarized antenna of claim 9, wherein the core is at least partially filled with a dielectric material having a dielectric constant greater than that of air.

13. The circularly polarized antenna of claim 1, further comprising a core about which the generally helical wire is at least partially wound.

14. The circularly polarized antenna of claim 1, wherein the cable extends substantially along a central longitudinal axis of the generally cylindrical passage.

15. The circularly polarized antenna of claim 1, wherein the generally helical wire and the first ground plane are adapted and dimensioned to transmit electromagnetic signals having an axial ratio of less than 3 dB.

16. The circularly polarized antenna of claim 1, wherein the generally helical wire and the first ground plane are adapted and dimensioned to transmit electromagnetic signals with a gain of approximately 6 dBi.

17. The circularly polarized antenna of claim 1, wherein the cable comprises a coaxial cable, and a shield of the coaxial cable is electrically coupled to the first ground plane and a core of the coaxial cable is electrically coupled to the generally helical wire.

18. A wireless interrogator for emitting wireless interrogation signals, comprising:
a wireless signal generator; and
a circularly polarized antenna coupled to the wireless signal generator, the circularly polarized antenna including:
a generally helical wire defining a generally cylindrical passage having a first end and a second end;
a first ground plane proximate the first end of the generally cylindrical passage, the first ground plane having a width substantially equal to a diameter of the generally cylindrical passage; and
a cable extending through the generally cylindrical passage and communicatively coupled to the wireless signal generator, the cable electrically coupled to the first ground plane and to the generally helical wire proximate the first end.

19. The wireless interrogator of claim 18, wherein the generally helical wire and the first ground plane are adapted and dimensioned to transmit electromagnetic signals in backfire mode in a direction from the second end to the first end.

20. The wireless interrogator of claim 19, wherein a substantial majority of the electromagnetic signals transmitted by the circularly polarized antenna during operation are transmitted in a 90 degree cone centered about a central longitudinal axis of the generally cylindrical passage, the 90 degree cone originating at the second end and extending in the direction from the second end to the first end.

21. The wireless interrogator of claim 20, wherein the substantial majority of the electromagnetic signals transmitted by the circularly polarized antenna during operation are transmitted in a 70 degree cone centered about the central longitudinal axis of the generally cylindrical passage, the 70 degree cone originating at the second end and extending in the direction from the second end to the first end.

22. The wireless interrogator of claim 18, wherein the circularly polarized antenna further includes a second ground plane proximate the second end of the generally cylindrical passage, the second ground plane having a width substantially equal to the diameter of the generally cylindrical passage.

23. The wireless interrogator of claim 22, wherein the second ground plane is adapted and dimensioned to function as a reflector during operation.

24. The wireless interrogator of claim 18, wherein the circularly polarized antenna further includes:
a cable port proximate the second end of the generally cylindrical passage, the cable port coupled between the cable and the wireless signal generator.

25. The wireless interrogator of claim 18, wherein the circularly polarized antenna further includes a radome substantially surrounding the generally helical wire.

26. The wireless interrogator of claim 25, wherein the circularly polarized antenna further includes a core about which the generally helical wire is at least partially wound.

27. The wireless interrogator of claim 26, wherein the radome, the core and the generally cylindrical passage are substantially concentric.

28. The wireless interrogator of claim 26, wherein the core is hollow.

29. The wireless interrogator of claim 26, wherein the core is at least partially filled with a dielectric material having a dielectric constant greater than that of air.

30. The wireless interrogator of claim 18, wherein the circularly polarized antenna further includes a core about which the generally helical wire is at least partially wound.

31. The wireless interrogator of claim 18, wherein the cable extends substantially along a central longitudinal axis of the generally cylindrical passage.

32. The wireless interrogator of claim 18, wherein the generally helical wire and the first ground plane are adapted and dimensioned to transmit electromagnetic signals having an axial ratio of less than 3 dB.

33. The wireless interrogator of claim 18, wherein the generally helical wire and the first ground plane are adapted and dimensioned to transmit electromagnetic signals with a gain of approximately 6 dBi.

34. The wireless interrogator of claim 18, wherein the cable comprises a coaxial cable, and a shield of the coaxial cable is electrically coupled to the first ground plane and a core of the coaxial cable is electrically coupled to the generally helical wire.
